(19) United States
(12) Patent Application Publication
(10) Pub. No.: US 2007/0203927 A1
(43) Pub. Date: Aug. 30, 2007

(54) System and method for defining and inserting metadata attributes in files

(75) Inventors: Ellis K. Cave, Plano, TX (US); David C. Cheng, Plano, TX (US)

Correspondence Address: FULBRIGHT & JAWORSKI L.L.P, 2200 ROSS AVENUE, SUITE 2800, DALLAS, TX, 75201-2784, US

(73) Assignee: InterVoice Limited Partnership, Dallas, TX (US)

(21) Appl. No.: 11/361,324

(22) Filed: Feb. 24, 2006

(51) Int. Cl. G06F 7/00

(52) U.S. Cl. 707/101

(57) ABSTRACT

In one embodiment, file attributes of a desired file are sent along with the URL to the storing server and the attributes are used for subsequent retrieval of the file. Attributes, such as the text or title of the file, the language of the file, the creator of the file, etc, can all be added to the file in the form of metadata. Files that are recorded without metadata can have metadata attached thereto and can be retrieved using the metadata. The URL initially carries the metadata to the server and the server then both uses the metadata for indexing purposes and, if desired, adds the metadata to the file for storage with the file. In one embodiment, the files are media files used in an IVR system.

### CONCURRENTLY FILED APPLICATIONS

The present application is related to copending and commonly assigned U.S. patent application Ser. No. ______ [Attorney Docket No. 47524-P137US-10501428] entitled “SYSTEM AND METHOD FOR ORGANIZING FILES ON A FILE SERVER USING METADATA INDEXING AND A SEARCH ENGINE,” patent application Ser. No. ______ [Attorney Docket No. 47524-P138US-10501429] entitled “SYSTEM AND METHOD FOR RETRIEVING FILES FROM A FILE SERVER USING FILE ATTRIBUTES,” and patent application Ser. No. ______ [Attorney Docket No. 47524-P140US-10506201] entitled “SYSTEM AND METHOD FOR DEFINING, SYNTHESIZING AND RETRIEVING VARIABLE FIELD UTTERANCES FROM A FILE SERVER,” filed concurrently herewith, the disclosures of which are hereby incorporated by reference.

### TECHNICAL FIELD

This invention relates to file storage and retrieval systems in general and more particularly to such systems and methods for adding metadata to files.

### BACKGROUND OF THE INVENTION

It is now commonplace to retrieve data files from storage locations. In the situation, files are stored on the same system handling the request for the file. Situations arise where it is desired to have several systems access a common set of files. This can be accomplished by setting up a file storage arrangement that is shared across a network. In such file storage arrangements, whether the arrangement serves one system or a plurality of systems, the desired file is retrieved by specifying the name of the file, as well as the full directory path to the file, when required. Thus, files may be moved about over the network arbitrarily.

Such an arrangement has problems when metadata is associated with the different files. Typically, metadata associated with a file is placed in a separate database. Thus, the database must be moved each time a file is moved.

One example of a complex file structure is the audio file structure used in interactive voice response (IVR) systems. In order for a script to play a specific audio file, the <audio> tag in the script must provide a fully resolved address or URL pointing to the web address where the desired audio file resides. The fully resolved address is a complete address to the file through the existing hierarchical structure. The server then directs the request to the desired address and the desired audio file is retrieved from the specified address.

While a hierarchical directory structure with full path-name access is effective, it has some drawbacks. Many applications, particularly media applications which use audio files, have thousands of such audio files. An application may have the same audio files recorded in multiple languages, multiple speakers, or different emotional tones (stern, happy). Deciding on a hierarchical folder and file-naming scheme can be a challenge. Should one file the files according to language? To speaker? To content? If one files according to language, how does one find all the files by a specific speaker? Thus, using a hierarchical storage structure and fully resolved path names to retrieve a particular file is cumbersome and often limiting. Storing files in a nonhierarchical structure and requesting the files by attribute, provides a more flexible approach to file access than hierarchical structures.

### BRIEF SUMMARY OF THE INVENTION

In one embodiment, metadata attributes of a desired file are sent along with a submit tag to a file server, and the specialized file server associates the metadata with the file before or during file storage. The metadata may be embedded within the file during the storage. The attributes may be used for subsequent retrieval of the file. Attributes, such as the text or title of the file, the language of the file, the creator of the file, etc, can all be associated with the file in the form of metadata. Files that are recorded without metadata can have metadata associated therewith and may be retrieved using the metadata.

In this patent's embodiment, metadata is NOT embedded into a file before the file is stored into the file server. For example, utterances recorded during the execution of an application, and streamed “whole call” recordings, both do not typically have metadata embedded when they are created. To facilitate metadata storages, the embodiment initially carries the metadata to the server, and the server embeds the metadata in the file as part of the storage process. The metadata may also be used to index the file.

In a further embodiment, the metadata and files are used in an IVR system. This embodiment may embed metadata in recorded audio files at the time the files are being stored on the file server. The files may then be located and retrieved using the metadata attributes instead of pathnames.

In a still further embodiment, aspects of the embodiment are intended for audio files that are created during the course of an application, when there are no processes that can be embed the metadata before sending the file to the audio file server. Note that prompts are typically created and their associated metadata is known well before their storage. However, it requires a detailed knowledge of the specific file structure to safely embed metadata in a file without damaging the original file data. Many applications do not have any processes that have the knowledge of file structures, so the embedding process is relegated to the specialized file server. However, aspects of the embodiment may be used with prompts.

### BRIEF DESCRIPTION OF THE DRAWINGS

For a more complete understanding of the present invention, reference is now made to the following descriptions taken in conjunction with the accompanying drawings, in which:

FIGS. 1A and 1B depict a system and method for embedding metadata within a file according to embodiments of the invention;

FIGS. 2A and 2B depict a system and method for embedding metadata within audio file for use in an IVR system according to embodiments of the invention.

### DETAILED DESCRIPTION OF THE INVENTION

Embodiments of the invention define how a file can be placed on a server while embedding metadata attributes into the file. The metadata may have been created before, simultaneously, or after creation of the file. In some cases, the metadata may already have been embedded into or associated with its respective file before it is be stored on a file server. In such a case, a standard HTTP “PUT” may be used to store the metadata-embedded file on the file server in a generic folder. When the already-metadata-embedded file arrives at the server, it may be indexed and stored by the server. Placing files with pre-embedded metadata on the file server is described in U.S. patent application Ser. No. ______ [Attorney Docket No. 47524-P137US-10501428] entitled “SYSTEM AND METHOD FOR ORGANIZING FILES ON A FILE SERVER USING METADATA INDEXING AND A SEARCH ENGINE,” and U.S. patent application Ser. No. ______ [Attorney Docket No. 47524-P138US-10501429] entitled “SYSTEM AND METHOD FOR RETRIEVING FILES FROM A FILE SERVER USING FILE ATTRIBUTES,” the disclosures of which are hereby incorporated by reference, and is not covered in this patent.

Embodiments of the invention are directed to situations where a file to be stored does not have embedded or associated metadata, and the process that will create or send the file does not embed or associate metadata in the file. One specific problem with embedding metadata in files in general is that the embedding process needs understand the file structure and format of the file that is being modified to embed the metadata. If the embedding process does not understand the target file format, then the target file may be corrupted or the data in the file may be destroyed.

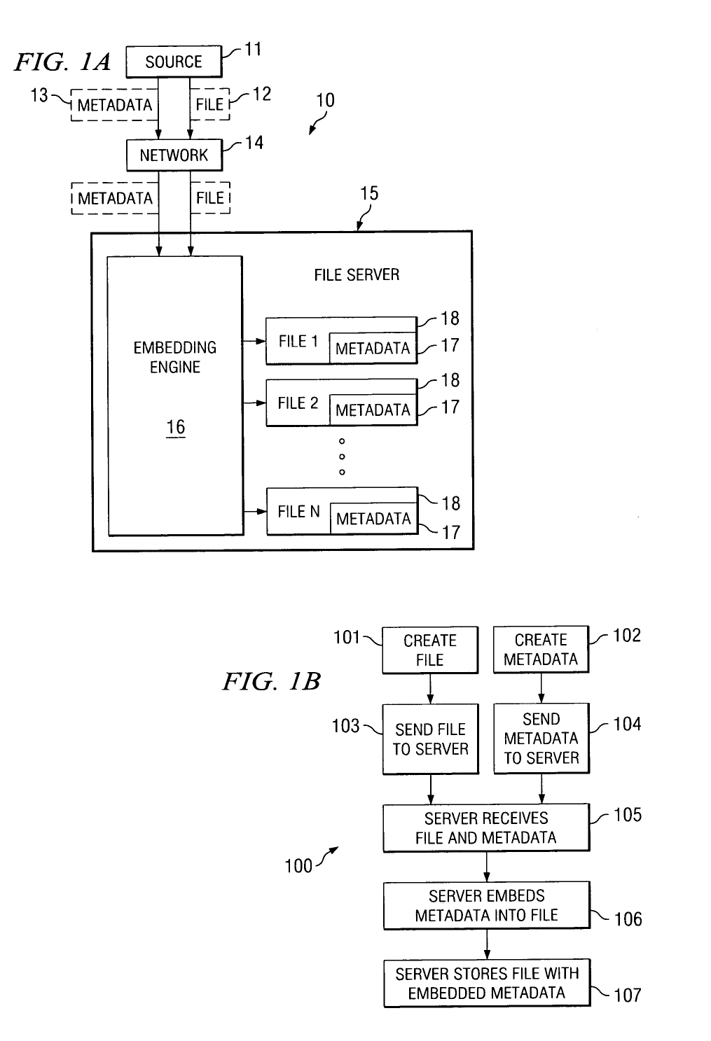

FIG. 1A depicts a system 10 for embedding metadata into a file. A source 11 creates a file 12 and metadata 13. The file may be any type of data file, including but not limited to a text file, an image file, a video file, an audio file, etc. The metadata may include the date, time, a source ID, an author, language, content description, etc. The file 12 and the metadata 13 may be provided to file server 15 via a network 14. Alternatively, the source 11 may be directly connected to the file server 15. The file server 15 includes a metadata embedding engine 16 that embeds the metadata within a particular file and a file storage section 18. Note that each stored file has embedded metadata 17. The metadata may be embedded at the end of a file, at the beginning of a file, or in the middle of a file. The format of the specific file type will determine where the metadata can be embedded in the file, without destroying any existing data in the file.

FIG. 1B depicts an exemplary method for embedding metadata with a file, for example, for use with the system of FIG. 1B. The method begins with the formation of the file 101 and the formation of the metadata 102. Note that the metadata may be formed prior to, contemporaneously with, or after the formation of the file. Next the file and the metadata is sent to the file server concurrently, in blocks 103 and 104, respectively. Note that, similarly, the metadata may be sent prior to, contemporaneously with, or after file has been sent. Metadata (or a file) arriving at the server prior to its associated file (or metadata) may be held in a buffer until the file (or the metadata) arrives. The metadata may include an ID tag that identifies its associated file. This would allow the metadata to be paired with and embedded into the proper file. In any event, both the file and the metadata will be received by the file server 105. The method then embeds the metadata within the file 106. Note that the embedding entity, e.g. embedding engine 16 should understand the file structure and format of the file to properly embed the metadata. Then both the file with the embedded metadata is stored in the file server 107.

One embodiment of the invention is directed to metadata and files are used in an IVR system. When a VXML system records a message from a user, the file is stored on the VXML browser until the recording is completed. Once the recording has finished the file is moved to the file server using a VXML PUT command. However, without embodiments of the invention, this action would place the file on the file server with no embedded metadata. Embodiments of the invention put the file in the server, and embed metadata in the file. Other embodiments put the file on the file server and embed the metadata at the same time.

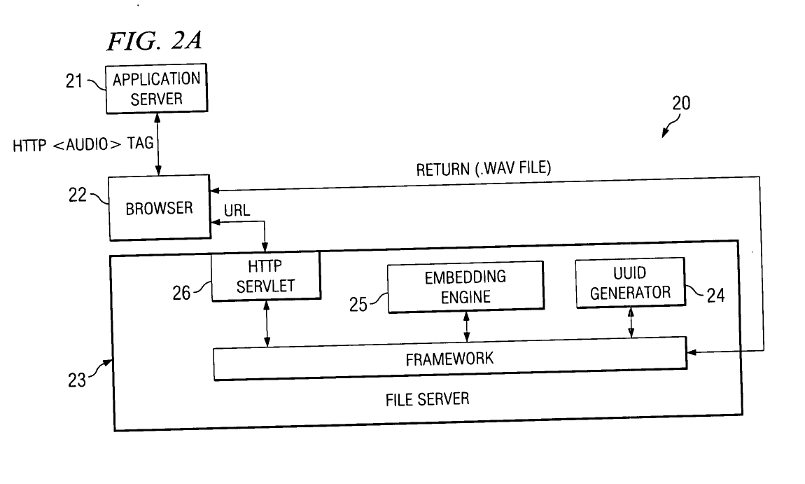

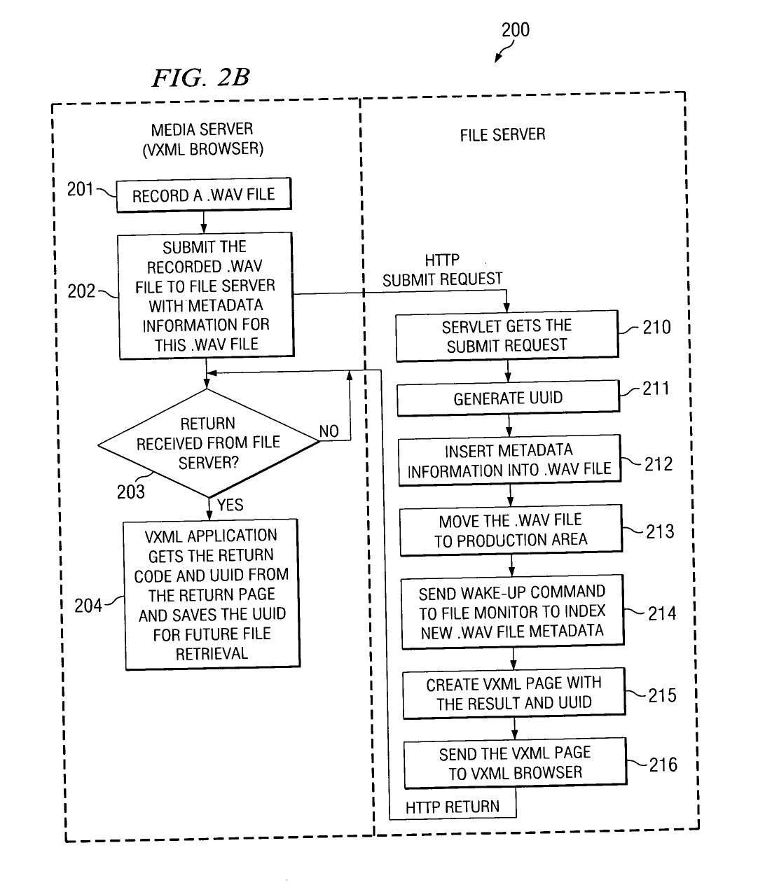

FIG. 2A shows one embodiment of system 20 for storing files onto file server 23 using an unresolved address structure.

In system 20, an application server 21, creates a document using the VXML scripting protocol, and communicates the document with browser 22, using, for example, the standard HTTP protocol to the file server 23.

A script can use VXML <record> tag to do the recording and save the filename in “recordMessage” variable. The “recordMessage” will be passed as last parameter in the namelist in the storeMedia servlet call.

<record name=“recordMessage” beep=“true” maxtime=“60000ms”
finalsilence=“3000ms” dtmfterm=“true” type=“audio/x-wav”>
</record>

After the recording is done, the script can use <submit> in the <subdialog> to submit the recorded message to the file server. The first parameter in the namelist will be the staging directory that file server is configured to use. A result for this submit will be returned to the application “submitFile.result” and the recorded file name in file server will also be returned to the application “submitFile.uuid. Between the first and last parameters in the namelist will be a list of metadata goes into the message. In the following example, <appName, BankA>, <accountName, 12345678>, and <question, What is my checking account balance”> are the metadata <key, value> for this message. In this example, the hardcoded string is put into expr and application can get the information (metadata) from the caller and passed into the expr as variable.

<subdialog name=“submitFile”> src=#submitWaveFile

<filled>

<assign name=“result” expr=“submitFile.result”/>
<assign name=“uuid” expr=“submitFile.uuid”/>

</filled>

</subdialog>
<form id=“submitWaveFile”>

<filled>

```
  <assign name=“dialog.root”
  expr=“‘d:/MediaHub/stageDir’”
```

/>

<assign name=“dialog.appName” expr=“‘BankA’” />
<assign name=“dialog.accountNumber” expr=“‘12345678’”
/>
<assign name=“dialog.question” expr=“‘What is my
checking

account balance’” />

<submit

next=“http://MediaHub:8080/MediaHubServlet/storeMedia” namelist=
“root appName accountNumber question recordMessage”
enctype=“multipart/form-data” />

</filled>

</form>

Below is the VXML script sent back from file server so that browser can get the result and UUID. Application can get the result from the <submit> in the <subdialog> call. UUID can be used for future media retrieval from the file server.

<?xml version=‘1.0’?>
<vxml version=\“2.0\” xmlns=\“http://www.w3.org/2001/vxml\”>
<form>

<block>

<var name=“result” expr=“‘OK’”/>
<var name=“uuid” expr=“‘5D3G-4YSD6-AUNX8’”/>
<return namelist=“result uuid”/>

</block>

</form>
</vxml>

A result for this submit will be returned to the application “submitFile.result” and the recorded file name in the file server will also be returned to the application “submitFile.uuid.”

The metadata attributes (and their respective values) with this example includes account number (12345678) and question (what is my checking account balance). Note that the record file name is also passed in the call. When HTTP servlet 26 of file server 23, namely Media Hub server, receives the servlet call, it will store the media file in its staging area, add the metadata to the media file via concatenation engine 25, and then move the media file to “production area” with UUID filename provided by UUID generator 24

Below is an example VXML script sent back from the file server to the browser so that browser can have the result and UUID for future use.

<?xml version=‘1.0’?>
<vxml version=\“2.0\” xmlns=\“http://www.w3.org/2001/vxml\”>
<form>

<block>

<var name=“result” expr=“‘OK’”/>
<var name=“uuid” expr=“‘5D3G-4YSD6-AUNX8’”/>
<return namelist=“result uuid”/>

</block>

</form>
</vxml>

FIG. 2B shows one embodiment 200 of a process for placing metadata into a prompt server, such as file server 23, FIG. 2A, by using a browser, such as browser 22 (or any other device). In the embodiment shown in FIG. 2B, process 201 controls the recording of a file (such as a .wav file) without metadata being incorporated into the file. Process 202 submits the newly created file to the file server and sends the desired attributes or the file (metadata) via a Submit tag and subdialog script.

HTTP servlet 26 in the prompt server (process 210) fetches the file from the temp storage on the browser. Process 212 generates a UUID for the file. This generates a unique name for the file, and avoids duplicate names in the file storage system.

Process 212 inserts the metadata into the .wav file and the .wav file is moved, via process 213, to the production area of the prompt server. Process 214 sends a wake-up call to the file monitor, so that the new metadata may be indexed immediately instead of waiting for indexing on a timed basis.

Process 215 creates VXML page with the result and the UUID and process 216 sends the VXML page to the VXML browser, if desired. The purpose of sending this page is to give information to the browser for subsequent retrieval of the file.

Process 203, in the browser, determines when a new browser page has been received. When it has, process 204 processes the return such that the browser obtains the code and UUID from the created page and the UUID is saved (if desired) for future file retrieval purposes.

Note that embodiments of the invention are useful for the types of files that do not get metadata inserted in at file creation time, such as audio messages recorded on a voice browser during the course of an application, and audio streams of telephone conversations coming from the network. Files recorded on the VXML browser are usually recordings of user utterances such as voicemail messages, personal notes and comments, messages for transcription, etc. that are created during the process of running the application (unlike prompts, which are created before the application is run). These file typically need to be stored on the audio file server for later retrieval. The VXML “record” command can create these types of files on a VXML browser, but the VXML record command does not comprehend metadata in the recorded file. When the recording is finished on the browser, the complete recorded file is transmitted to the audio file server.

Full recordings of telephone conversations are typically streamed directly into the audio file server, and will not pass through the browser. Whatever process instigates the audio streaming should also inform the file server of the metadata to be added to the file after the recording is stopped. The final file with its inserted metadata is then placed into storage.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method of storing files, said method comprising:
sending to a server a file to be stored under control of said server, said sending being controlled by a URL associated with the file being sent; and
appending as a query string to said URL attributes to be embedded within said file.

2. The method of claim 1 further comprising:
parsing said query string by said server to obtain said attributes.

3. The method of claim 2 further comprising:
appending said parsed attributes to said file.

4. The method of claim 2 wherein said server stores said file in accordance with said URL.

5. The method of claim 2 wherein said server stores said file with said attributes appended thereto in accordance with said URL.

6. The method of claim 2 further comprising:
storing said parsed attributes in said server's search index files.

7. The method of claim 6 further comprising:
retrieving said file by said server's search engine based on one or more of said files attributes being provided to said server.

8. A file server comprising:
means controlled at least in part by a URL command string for receiving a file attached to said URL, said file to be stored under control of said server; and
means for retrieving from said URL string metadata for embedding within said file.

9. The file server of claim 8 further comprising:
means for indexing said metadata in said server's search index; and
means for storing said file in accordance with said URL.

10. The file server of claim 9 wherein said retrieving means comprises:
using the “?” marker in the HTTP protocol of said URL to identify said metadata.

11. The file server of claim further comprising:
means for retrieving said file by parsing at least one attribute of said file, said attribute contained in said metadata.

12. A web based IVR system comprising:
a browser for creating media files, said media files not having metadata embedded in said files;
a file server in communication with said browser, said communication on an HTTP protocol communication line using VXML protocol wherein each said created file is communicated for storage at said file server at locations identified by a URL; and
said browser using a query string associated with said URL for attaching metadata to certain of said files when said files are being delivered to said file server.

13. The web based IVR system of claim 12 wherein said file server is operable for identifying said metadata on said communication line and for indexing said metadata for subsequent retrieval of said file associated with said metadata.

14. The web based IVR system of claim 13 wherein said file server is further operable for storing said file under control of said URL.

15. The method of receiving files at a file server, said method comprising:
storing received files in accordance with a URL instruction;
identifying attributes of said file by using other data associated with said URL; and
storing said attributes of said file in a search index.

16. The method of claim 15 further comprising:
adding said identified attributes to said file prior to said storing.

17. The method of claim 15 further comprising:
retrieving said file based upon receipt of at least one of said attributes, said at least one attribute coming associated with a URL, said URL not fully resolving the location of said file.

18. The method of claim 17 wherein said at least one attribute is attached to said URL as a query.

19. The method of claim 17 wherein said attribute are in the form of a decorated URL from a browser and wherein said URL is in compliance with VXML protocol.

20. A computer program product comprising:
code for sending to a server a file to be stored under control of said server, said sending being controlled by a URL associated with the file being sent; and
code for appending as a query string to said URL attributes to be associated with said file.

21. The computer program product of claim 20 further comprising:
parsing said query string by said server to obtain said attributes.

22. The computer program product of claim 21 further comprising:
appending said parsed attributes to said file.

23. The method of claim 22 wherein said server stores said file with said attributes appended thereto in accordance with said URL.

24. The method of claim 21 wherein said server stores said file in accordance with said URL.

25. The method of claim 21 further comprising:
storing said parsed attributes in said server's search index files.

26. The method of claim 25 further comprising:
retrieving said file by said server's search engine based on one or more of said files attributes being provided to said server.
